(19) United States
(12) Patent Application Publication
(10) Pub. No.: US 2011/0085444 A1
(43) Pub. Date: Apr. 14, 2011

(54) FLOW AUTODETERMINATION

(75) Inventors: Kung-Ling Ko, Union City, CA (US); Surya Varanasi, Dublin, CA (US); Wei-Chung Huang, Fremont, CA (US); Venkata Pramod Balakavi, San Jose, CA (US)

(73) Assignee: BROCADE COMMUNICATIONS SYSTEMS, INC., San Jose, CA (US)

(21) Appl. No.: 12/577,868

(22) Filed: Oct. 13, 2009

(51) Int. Cl. H04L 12/26

(52) U.S. Cl. 370/236

(57) ABSTRACT

Autodetermination circuitry examines packets transmitted internally to an egress port of a switching device in order to learn the associated flow. The autodetermination circuitry maintains a flow memory recording the highest traffic volume flows and unlearns the flows exhibiting lower traffic volumes to make room for other higher traffic volume flows. Accordingly, as some flows decrease in traffic volume and other flows increase in traffic volume, the flows decreasing below a threshold are dropped from a flow memory, and other flows increasing in volume above the threshold are added to the flow memory. In this manner, only the most likely offending flows are maintained in the flow memory. Accordingly, when congestion is detected, the switching device can identify one or more source devices contributing the most to the congestion and take steps to alleviate the congestion by decreasing the traffic volume originating from one or more of those sources.

### BACKGROUND

Communications networks typically handle an enormous number of source-to-destination communication flows. Within a communications network, such flows travel from a source device to a destination device through one or more switching devices. When more than one switching device is traversed by a flow, an interswitch link is used to connect the pair of switching devices. Under certain circumstances of high traffic volume, the interswitch link between any two switching devices may become congested, thereby slowing the communication of all traffic flowing through that same link. For example, the congestion may be caused by a source device (e.g., a server, a workstation, a storage device, etc.) transmitting an unexpectedly large amount of traffic over the interswitch link. However, all traffic flows through that interswitch link may experience a decrease in performance caused by the traffic originating from that one offending source device.

However, an interswitch link can carry thousands or millions of flows within a specified time period. As such, when such congestion at an interswitch link is detected in a communications network, it is difficult or unfeasible to resolve the congestion, in part because of the problem of determining specifically which of the large number of flows is having a substantial negative effect on the congestion. That is, with so many flows, it may not be possible to quickly and economically identify the offending flow (and therefore the offending source device) among all of the lower volume flows on the congested interswitch link.

Furthermore, concurrently monitoring and maintaining a flow traffic volume record of all flows through an interswitch link presents a substantial resource obstacle. For example, exhaustive monitoring of the enormous number of source-to-destination communications flows would require large and prohibitively expensive memories in each switching device.

### SUMMARY

Implementations described and claimed herein address the foregoing problems by continuously examining packets transmitted internally through an egress port of a switching device and over an interswitch link connected to the egress port to learn the flows passing through the switching device. Autodetermination circuitry maintains a dynamic record of the highest traffic volume flows, unlearning a subset of the flows satisfying a culling condition (e.g., those flows exhibiting lower traffic volumes) to make room for other higher traffic volume flows. Accordingly, as some flows decrease in traffic volume and other flows increase in traffic volume, the flows decreasing below a threshold are dropped from a datastore (e.g., a list or table stored in a flow memory) and other flows increasing in volume above the threshold are added to the datastore. In this manner, only the most likely offending flows are maintained in the datastore, thereby reducing the resource requirements of the datastore.

Accordingly, when congestion is detected, the switching device can access the datastore to identify one or more source devices that are contributing the most to the congestion and then take steps to alleviate the congestion by decreasing the traffic volume originating from one or more of those sources. Various methods of remediating the congestion may be employed, including without limitation (1) rerouting the flow through a different set of switching devices; (2) imposing a lower transmission rate limit on the offending source device(s); and (3) allocating additional bandwidth to the congested interswitch link.

Other implementations are also described and recited herein.

### BRIEF DESCRIPTIONS OF THE DRAWINGS

FIG. 1 illustrates a communications network with a congested interswitch link between two switches that provide example flow autodetermination features.

FIG. 2 illustrates an architecture of an example network switching device providing flow autodetermination features.

FIG. 3 illustrates an example flow memory with a single flow stored therein.

FIG. 4 illustrates an example flow memory that is full of flows.

FIG. 5 illustrates an example flow memory with sorted flows.

FIG. 6 illustrates an example flow memory after culling.

FIG. 7 illustrates an example flow memory refilled with additional flows.

FIG. 8 illustrates example operations for determining flows contributing to congestion on a link.

FIG. 9 illustrates alternative example operations for determining flows contributing to congestion on a link.

FIG. 10 illustrates an architecture of an example Fibre Channel Controller in which the autodetermination features can be implemented.

### DETAILED DESCRIPTIONS

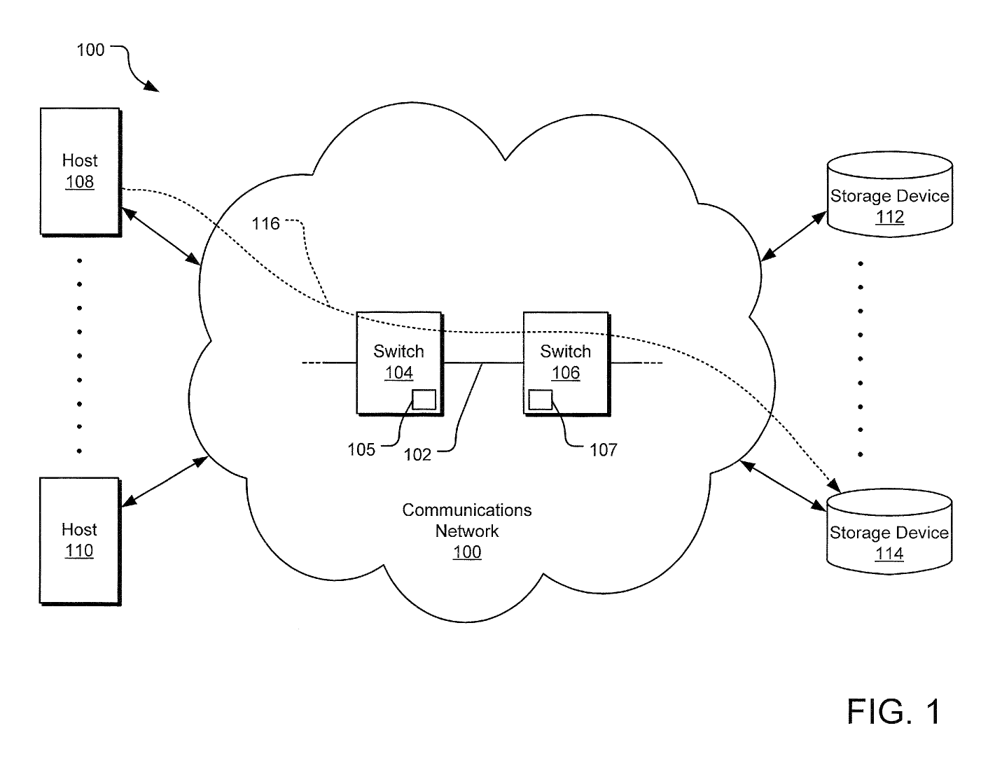

FIG. 1 illustrates a communications network 100 with a congested interswitch link 102 between two switches 104 and 106 that provide example flow autodetermination features. The switches 104 and 106 are coupled through the communications network 100 between various nodes, such as hosts 108 and 110 and storage devices 112 and 114. Each switch 104 and 106 includes autodetermination circuitry (see circuitry 105 and 107) that executes a flow autodetermination function. In one implementation, each switch 104 and 106 monitors the traffic it transmits through an egress port and over the interswitch link 102, and monitors for congestion on the interswitch link 102. If the switch detects congestion on the interswitch link 102, each switch evaluates the communication flows it is transmitting across the interswitch link 102 and can take remedial action to alleviate the congestion.

In the illustrated example, communication flows travel from a source device (e.g., the host 108) to a destination device (e.g., the storage device 114) through the switches 104 and 106 and the interswitch link 102. For example, the host 108 may be backing up to the storage device 114 through the interswitch link 102 in one source-to-destination flow 116 while other nodes on the network 100 are also communicating through the same interswitch link 102 in separate source-to-destination flows (not shown). If the aggregate traffic volume of all of these flows exceeds bandwidth of the interswitch link 102, then congestion results in the interswitch link 102, which can lead to reduced performance of all of the traffic flows in the interswitch link 102.

One or both of the switches 104 and 106 may detect this congestion and then execute remedial actions to alleviate the congestion. In one implementation, a switch can detect congestion by detecting that a receive queue feeding an egress port of the switch is full (or exceeds a threshold). In an alternative implementation, a switch can detect congestion by detecting that a transmit queue on an egress port of the switch if full (or exceeds a threshold). In either case, the link connected to the egress port is identified as “congested”. Other congestion detection techniques may be employed.

In one implementation, detection of congestion results in a congestion signal being sent to a processor in the switch, although in various implementations, a single congestion event need not lead to issuances of a congestion signal. Instead, the switch can include a counter that maintains a record of individual congestion events on a link. If the congestion counter satisfies a congestion condition (e.g., exceeds a threshold in a predetermined period), then the congestion signal is sent to the processor to address the detected congestion condition. In this manner, minor, intermittent congestions events do not trigger flow autodetermination and/or congestion remediation. Nevertheless, other configurations may be employed such that any number of detected congestion events trigger flow autodetermination and/or congestion remediation.

In the case of a back-up operation between the host 108 and storage device 114, a large volume of traffic is flowing from the host 108 to the storage device 114 over the interswitch link 102. Accordingly, the switch 104 can detect congestion on the interswitch link 102, evaluate the flows it is transmitting across the interswitch link 102, and execute an action that remediates the congestion in the interswitch link 102. It should be understood that the switch 106 can be concurrently performing the same operations from its perspective.

However, the interswitch link 102 may carry a very large number of flows (e.g., thousands or millions of flows). Monitoring and maintaining an exhaustive record of all of the specific flows that could be managed to alleviate the congestion on the interswitch link 102 during any specific time period can present an enormous bookkeeping task and consume scarce resources of a switch. Instead, the autodetermination circuitry 105 in switch 104 maintains a dynamically updated and culled record of flows and flow volumes in a reasonably sized flow memory for each interswitch link, thereby avoiding the necessity for large flow memory for each interswitch link supported by the switch 104. In one implementation, a 256 KB flow memory is employed for each communications link, which can support up to 1024 flows per link in each monitoring period.

As new flows are detected on the interswitch link 102, they are inserted as a flow entry in the flow memory maintained by the switch 104 (i.e., the flow is “learned” by the switch). Over time, the switch 104 continues to monitor flows, updating the flow memory with new flows and traffic volume updates for each recorded flow.

Periodically or in response to certain events, the autodetermination circuitry 105 interrupts the monitoring of the flows, sorts the recorded flows in the flow memory according to the flow traffic volume and keeps only a set of the highest traffic volume flows (e.g., a Top Ten List, those over a certain volume threshold, etc.) in the flow memory. The rest of the flows, which do not satisfy the culling condition (e.g. contributing lower traffic volumes to the interswitch link during the monitoring period), are culled (e.g., deleted or designated as “overwriteable”), also referred to as “unlearned,” thereby freeing up space in the flow memory for more monitored flows. As such, at each culling operation, a subset of all of the flows are culled from the flow memory for the associated link, leaving a set of higher traffic volume flows in the flow memory. The designation of overwriteable allows the autodetermination circuitry 105 to overwrite the designated flow entries in the flow memory, whereas the non-designated flow entries are preserved from overwriting during the next monitoring period.

The autodetermination circuitry 105 resets the flow traffic volume fields associated with the remaining flows in the flow memory and then continues to monitor the flows transmitted over the interswitch link 102 by the switch 104. As in the previous iteration, the autodetermination circuitry 105 continues to add newly detected flows to the flow memory (i.e., flows not currently stored in the flow memory) and increases the traffic volume for each already recorded flow.

This period of monitoring flows is referred to as the “monitoring period.” Depending on the size of the flow memory and the traffic flows expected through the associated interswitch link, the monitoring period may be set for a short period of time (e.g., minutes or seconds). In one implementation, the monitoring period is set to avoid exceeding the size of the flow traffic volume field in a flow entry in the flow memory. While maxing out the flow traffic volume field for a few flows would not be fatal to operation, the monitoring period may be adjusted downward to limit or avoid this condition. It should be understood that the resetting of the flow traffic volume fields for the retained flows in the flow memory also helps avoid maxing out the traffic volume fields each time the flow memory fills up.

Although in one implementation, the monitoring period is set as a function of time, other conditions may be used to end a monitoring period. For example, the monitoring period may be interrupted when the flow memory for a link is filled up with entries or a flow traffic volume field in a flow entry exceeds a threshold. Other monitoring period conditions may also be employed.

The autodetermination process continues to repeat these operations until congestion is detected on the interswitch link 102. At that point, the autodetermination circuitry 105 may identify one or more flows making a substantial contribution to the congestion on the interswitch link 102.

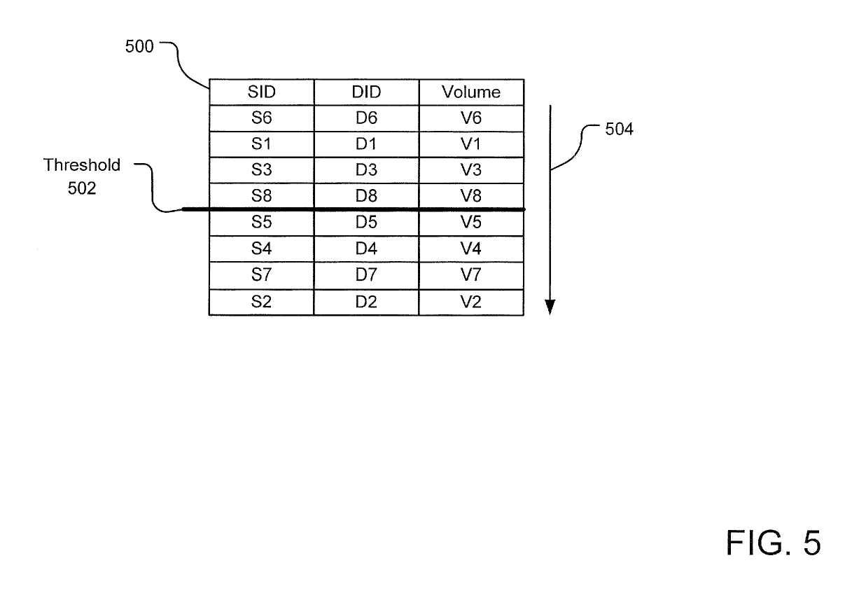

Any flow being transmitted across the interswitch link 102 can contribute to congestion. However, in light of the sorting and culling, the flows at the top of the flow memory (see the top of the example flow memory 500 in FIG. 5) have exhibited the highest traffic volumes during the most recent monitoring period and are therefore contributing the most to the congestion on the interswitch link 102 during that time. As such, one or more of these flows may be selected as an “offending flow” and may be identified for remediation so as to alleviate the congestion. In this discussion, flow 116 is identified as an “offending flow”.

Remedial action may take several forms. In one implementation, the routing of the “offending” flow 116 may be altered throughout the communications network 100 to route the flow 116 through a different “uncongested” link. This rerouting may start at the switch 104 and propagate through the rest of the communication network 100, may be applied at the boundary switch (not shown) connected to the host 108, or may be applied anywhere in between.

In another implementation, the switch 104 can initiate some manner of rate limiting at the host 108. For example, the boundary switch (not shown) to which the host 108 connects into the communications network 100 may be instructed reduce the credits available to the host 108, thereby reducing the transmission rate from the host 108 and therefore reducing the traffic volume in the flow 116 from the host 108 to the storage device 114 in the interswitch link 102.

In yet another implementation, the bandwidth available between the switch 104 and the switch 106 may be increased. For example, if the interswitch link 102 is embodied by a trunk of multiple, parallel communication links, additional communications links may be added to the trunk to increase the available bandwidth and alleviate the congestion. Alternatively, the routing between the switch 104 and the switch 106 may be altered to use a higher bandwidth port pair and interswitch link.

It should be understood that the switch 104 may configured to monitor and record only a subset of the flows that it transmits. Example flow parameters that may be specified to filter the monitored subset, including without limitations the source identifier (SID), destination identifier (DID), logical unit number (LUN), quality of service (QoS) level, etc. A filter condition is specified based on one or more of the flow parameters. If a flow satisfies the filter condition, then the flow can be ignored (e.g., not recorded) during the monitoring period. In this manner, for example, flows with a high QoS level can be removed from consideration and therefore will not be considered for remedial action—other lower QoS level flows will populate the flow memory and potentially selected for remedial action.

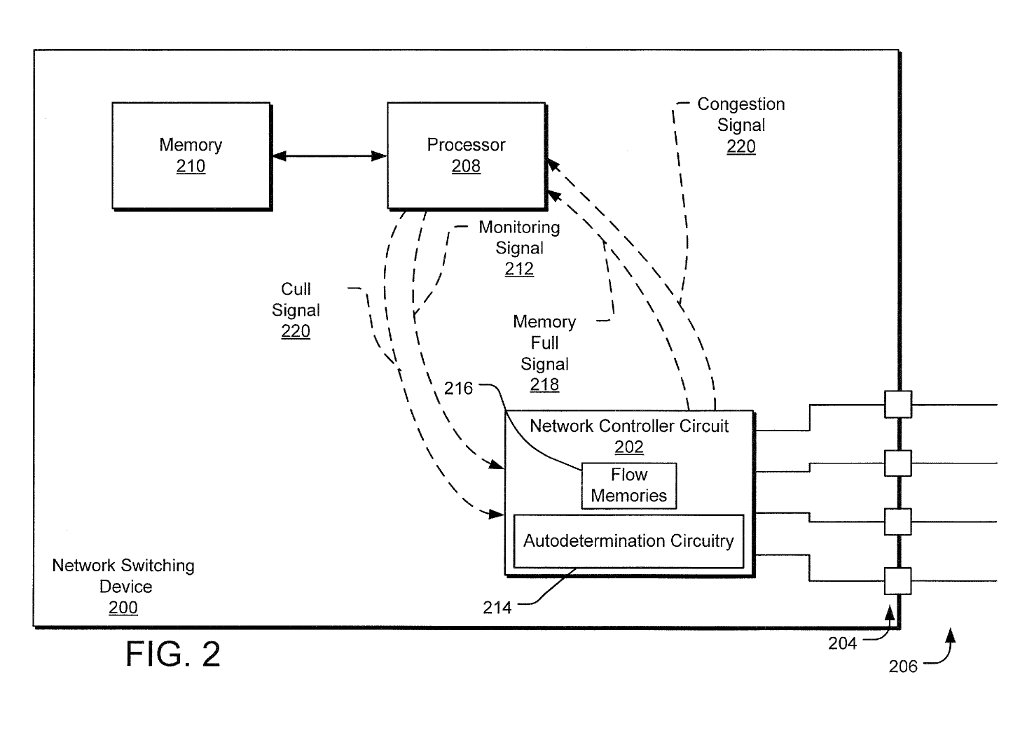

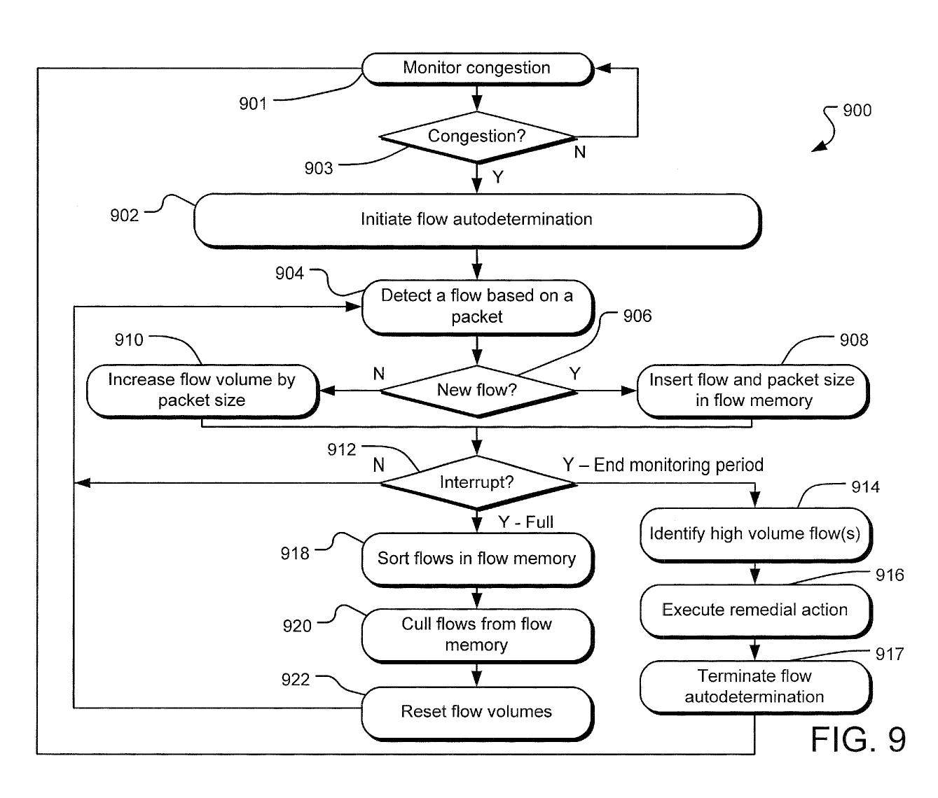

FIG. 2 illustrates an architecture of an example network switching device 200 providing flow autodetermination features. Among other components, the network switching device 200 includes at least one network controller circuit 202 (e.g., a Fibre Channel Controller circuit, a Gigabit Ethernet Media Access Controller (MAC) circuit, etc.) that manages communications through the egress ports 204 over interswitch links 206. In one implementation, the network controller circuit 202 embodies a 48-port Fibre Channel Controller circuit that, when combined with a Host Processor Subsystem and other components, can provide a complete 48-port 2G/4G/8G/10G/16G Fibre Channel switch. An example Fibre Channel Controller circuit is described in more detail with regard to FIG. 9, although it should be understood that other networking protocols (e.g., Gigabit Ethernet) may be employed instead of or in combination with Fibre Channel.

The network switching device 200 also includes a processor 208 and memory 210. The memory 210 stores instructions (e.g., in the form of a firmware or software program) executable by the processor 208. In the illustrated implementation, the instructions participate in the autodetermination process, such that the processor 208 and the network controller circuit 202 can monitor flows transmitted through egress ports 204 of the network switching device 200 and over one or more interswitch links 206 to identify one or more “offending” flows (e.g., those flows having greater contribution to congestion on the interswitch link).

In one implementation, the network switching device 200 is managed by an administrative program (not show) that can turn the flow autodetermination feature on and off. In other implementations, the autodetermination feature is initiated upon power-up and stays on during switch operation. In yet another implementation, the flow determination feature is initiated only after the switch detects a congestion condition on a link (e.g., one or more congestion events). Other implementations may also be employed.

After the autodetermination feature is initiated, the processor 208 instructs (e.g., via monitoring signal 212) autodetermination circuitry 214 in the network controller circuit 202 to begin monitoring traffic volume via the flows transmitted by the network controller circuit 202 over one or more of its interswitch links 206. In one implementation, the autodetermination circuitry 214 of the switch 200 detects flows by extracting flow parameters (e.g., SID and DID) from each data packet received by the switch 200. The flows detected by the autodetermination circuitry 214 are stored in one or more flow memories 216, such as content addressable memory (CAM) or storage element, according to each flow's SID and DID (e.g., examples of flow identifiers). The autodetermination circuitry 214 can evaluate the flow parameters to add a flow entry to the flow memory 216 or supplement a flow entry (e.g., increasing its flow traffic volume in the flow entry) in the flow memory 216.

In one implementation, a separate flow memory space of one or more flow memory devices are designated for each interswitch link 206. In this configuration, each flow memory space is considered a flow memory for an individual interswitch link.

If a flow is not yet stored in the flow memory 216, then the flow is inserted as a flow entry to the flow memory 216, including the size of the transmitted packet detected for that flow as a flow traffic volume in the flow entry. If the flow is already stored in the flow memory 216, then the size of the transmitted packet is added to the existing flow traffic volume field for that flow. In this manner, each flow detected by the autodetermination circuitry 214 is recorded in the flow memory 216 along with its accumulated contribution to traffic volume in the interswitch link 206 during the monitoring period.

When the flow memory 216 for a specific interswitch link fills up with flow entries, the network controller circuit 202 notifies the processor 208 via a memory full signal 218. The memory full signal 218 identifies the flow memory 216 (e.g., an identified of the flow memory 216 that is full, an identifier of the interswitch link associated with the full flow memory 216, etc.). Responsive to receipt of the memory full signal 218, the processor 208 instructs the autodetermination circuitry 214 to sort and cull its flow entries in the flow memory 216 via the cull signal 220. Responsive to receipt of the cull signal 220, the autodetermination circuitry 214 sorts the flow entries in the full flow memory 216 according the flow traffic volume and then deletes (i.e., culls) a set of flow entries having a lower traffic volume. Rather than deleting “culled” flow entries, the autodetermination circuitry 214 may merely designate the culled flow entries as “overwriteable,” thereby making flow memory room available for newly monitored flows in the next monitoring period.

After sorting, the set of retained and culled flow entries may be identified by setting a culling condition. Those flow entries satisfying the culling condition (e.g., falling below a traffic volume threshold, generically a “culling threshold”) are culled. In one implementation, if the flow memory 216 includes 1024 entries, then the culling condition may be specified as an entry count threshold, set to delete all flow entries lower than the top 100 flow entries (i.e., keeping those flows with the highest traffic volume). It should be understood that a condition to identify flow entries for culling can be defined inversely, so that satisfying a specified condition identifies those flow entries to be kept, rather than deleted. In either case, it can be said that the culled flow entries satisfy the culling condition—in the case of an inverse condition, the culling condition is satisfied if the flow entries not satisfying the inverse condition are culled.

Alternatively, the culling condition may be specified as a static or dynamic traffic volume threshold (generically a “culling threshold”), which may be statistical in nature. For example, all flow entries having a flow traffic volume within 20% of the highest traffic volume in the flow memory 216 may be retained and the rest may be culled. This type of threshold is dynamic in that it changes with the traffic volume of the highest volume flow entry.

Other culling conditions and culling thresholds may also be employed, such as combinations of the described thresholds and other thresholds. For example, a Boolean operation may be used to combine two entry count thresholds and/or a statistical traffic volume threshold with an entry count threshold (e.g., setting a threshold of 20% less than the highest volume flow but no more than 100 flow entries and no fewer than 10 flow entries may be kept after a culling operation).

After the flow memory 216 is sorted and culled, the flow traffic volume fields of the remaining flow entries are zeroed out and monitoring begins again. Because of the culling, the flow memory 216 includes flow entries of some of the highest traffic volume flows and also includes a large number of empty or overwriteable entries, which can be populated with new flows as they are detected. In this manner, the flow memory 216 learns and maintains flow entries for flows that are expected to have a high traffic volume. Likewise, flows that exhibit a lower traffic volume are unlearned (e.g., culled from the flow memory 216) so as to keep available empty flow memory space in which new flow entries can be stored. It should also be understood, during any monitoring period, a previously high volume flow may decrease its flow traffic volume, such that it is culled at the end of that monitoring period. Accordingly, the flow memory 216 stores a dynamically-updated snapshot of high volume flows.

When the network controller circuit 202 detects congestion, it signals the processor 208 via a congestion signal 220, which identifies the flows to be used for remedial action. As previously described, congestion detection counters may be applied to each link (or each egress port) configured for flow monitoring. If a congestion event is detected (e.g., associated receive or transmit queues fill up) on an interswitch link, the corresponding congestion detection counter is incremented. When a congestion detection counter exceeds a programmable threshold value, a congestion condition is satisfied and a congestion signal 220 is issued to the processor 208, identifying the congested interswitch link. Note: identifying the corresponding egress port also identifies the congested interswitch link. Responsive to receipt of the congestion signal 220, the processor 208 initiates remedial action to alleviate the congestion on the identified interswitch link.

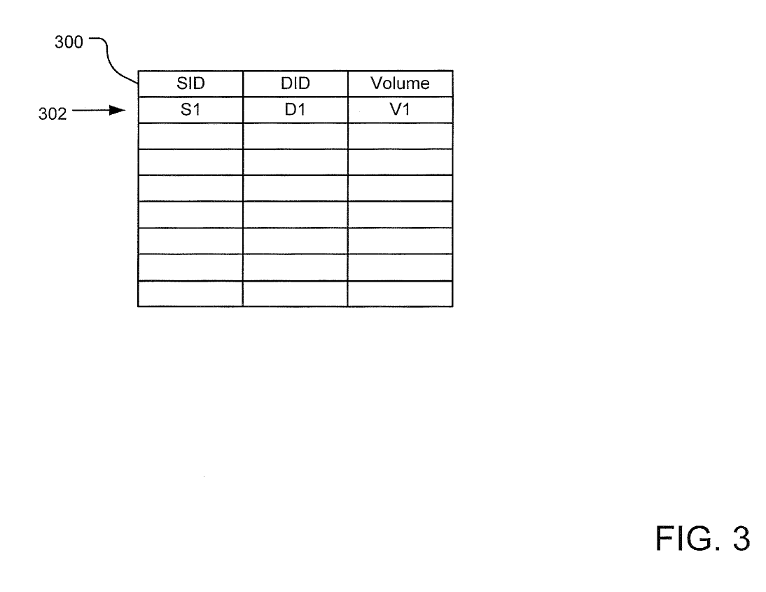

FIG. 3 illustrates an example flow memory 300 with a single flow 302 stored therein. Although the flow memory 300 presents only eight available entries for descriptive purposes, it should be understood that a typical flow memory contains a large number of available entries (e.g., 1024). In one implementation, the flow memory 300 is embodied by a CAM, although other memory configurations may be employed.

The flow memory 300, as illustrated, includes three fields: source identifier (SID), destination identifier (DID), and flow traffic volume (Volume), although other flow memories may include other fields, including flow parameters such as quality of service, logical unit number (LUN), etc. During a monitoring period, as the network controller circuit detects a flow, it checks the flow memory 300 to determine whether the flow has already been stored in a flow entry of the flow memory 300. If so, then the size of the detected packet of the flow is added to the volume of that flow in the flow memory 300. If not, then the SID, DID, and packet size of the detected packet of the low is inserted into the flow memory 300.

The monitored flows can also be filtered according to a filter condition based on one or more flow parameters. For example, the autodetermination circuitry can be configured by specifying a filter condition to ignore flows destined for a particular LUN. Alternatively, all flows may be collected into a flow memory, but a pre-culling filtering operation can be applied to delete flow entries that satisfy a specified filter condition.

It should be understood that an inverse condition may also be specified, such that all flows satisfying an inverse condition are recorded in the flow memory (i.e., not filtered out of the monitoring). Nevertheless, in this perspective, any flow not satisfying the inverse condition is deemed to satisfy the filtering condition and is therefore filtered out of the monitoring.

Further, filtering may be applied on a packet-by-packet basis. That is, any packet satisfying the filter condition is not used to add a new flow to the flow memory or to increase the flow traffic volume of a previously recorded (and still recorded) flow entry in the flow memory.

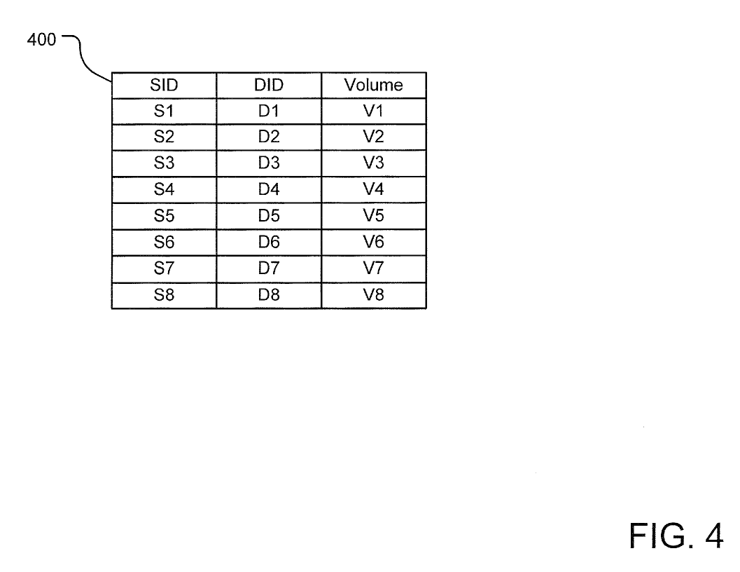

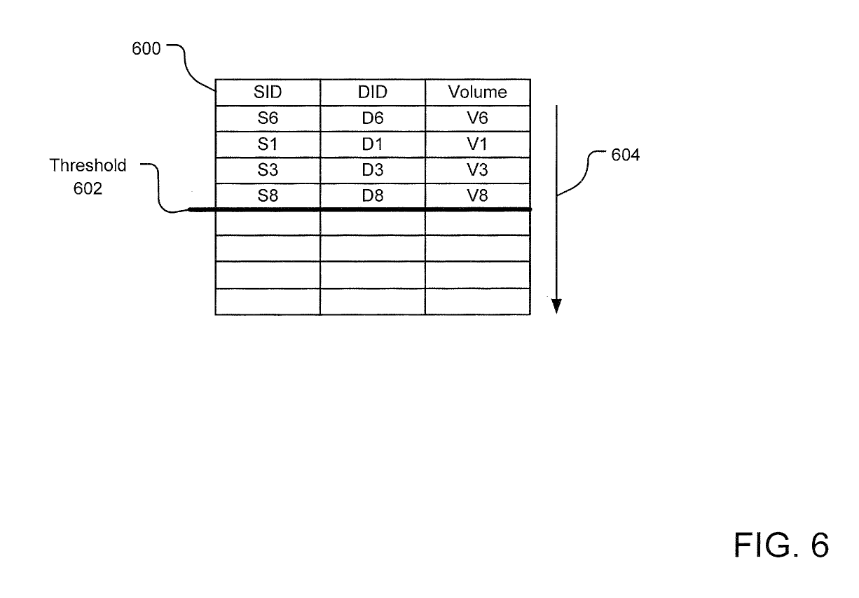

FIG. 4 illustrates an example flow memory 400 that is full of flows. Each entry (e.g., row) of the flow memory 400 is populated with a flow and its associated flow traffic volume during the monitoring period. Accordingly, the network controller circuit detects that the flow memory 400 is full and signals a processor that is executing software for flow autodetermination. The processor and software can then process the full flow memory 400 to make room for new flow entries, as discussed with regard to FIGS. 5 and 6.

FIG. 5 illustrates an example flow memory 500 with sorted flows. Responsive to a memory full signal from the network control circuit, the processor signals the network control circuit to sort and cull the flow entries in the flow memory 500. In FIG. 5, the flow entries are sorted (as indicated by arrow 504) according to flow traffic volume from highest (at the top) to lowest (at the bottom). As such, the flow traffic volumes may be described as:

V6≧V1≧V3≧V8≧V5≧V4≧V7≧V2

The culling condition has been specified as an entry count threshold 502 set at 4 flow entries from the top of the flow memory 500, after sorting. Alternatively, as previously discussed, other thresholds may be employed.

FIG. 6 illustrates an example flow memory 600 after culling. Because the entry count threshold 602 is set to retain the top four entries, the lower sorted flow entries are deleted. In this manner, the flow having the top four highest flow traffic volumes are retained in the flow memory 600 and the rest of the flow memory 600 is made available for newly detected flows, which may include previously detected and culled flows. As discussed, other types of thresholds may be employed. After culling, the remaining flow entries in the flow memory 600 are still sorted, as shown by arrow 604, at least until new flow entries are added.

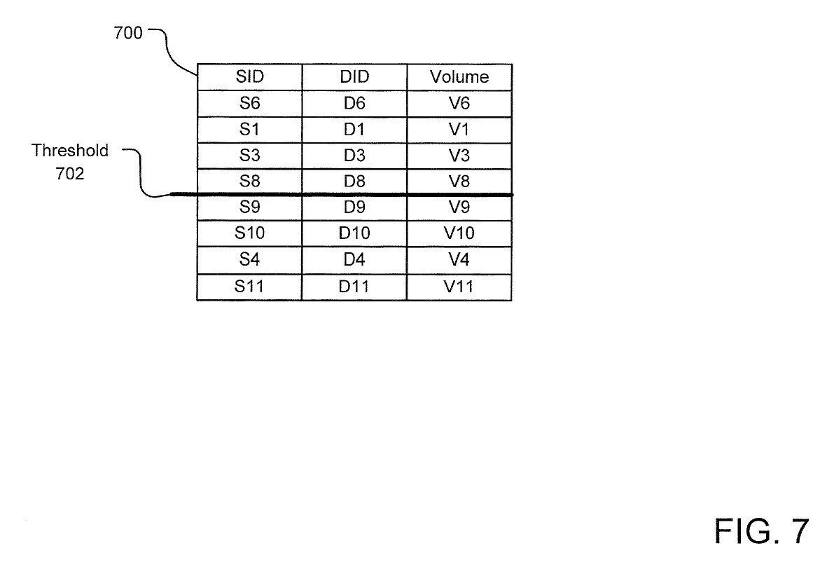

FIG. 7 illustrates an example flow memory 700 refilled with additional flows. Some of these flows may represent flows previously been stored and culled from the flow memory 700. Others may represent flows that had not previously been detected during a monitoring period.

The entry count threshold 702 is shown to be the same as shown in FIGS. 5 and 6. However, the threshold may be dynamically set in and/or during each monitoring period and may be changed among many different types of culling conditions (e.g., a entry count threshold to a flow traffic volume threshold). For example, given a statistical threshold (e.g., 20% of the maximum flow traffic volume), the threshold 702 may be adjusted at the end of each monitoring period based on the maximum flow traffic volume detected during that monitoring period.

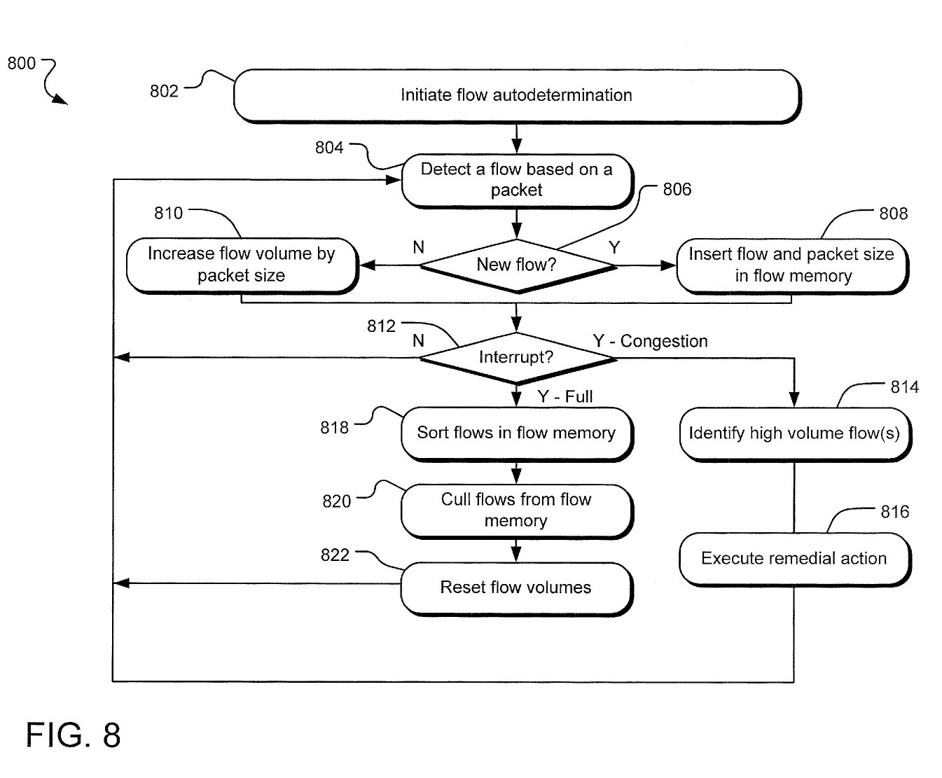

FIG. 8 illustrates example operations 800 for determining flows contributing to congestion on a link. An initiating operation 802 starts flow autodetermination within a network switching device. In one implementation, the network switching device receives an instruction from an administrative station to initiate flow autodetermination. In another implementation, the network switching device automatically initiates flow autodetermination upon power up. Other initiating operations may also be employed.

A detecting operation 804 evaluates a packet the network switching device transmits across a specific interswitch link, examining the packet's SID and DID and potentially other flow parameters. A decision operation 806 checks the flow memory to determine whether the flow associated with the evaluated packet is not already inserted into the flow memory. If not, the flow is a new flow and the SID, DID, and packet size of the packet are inserted into available space in the flow memory by an inserting operation 808. The size of the packet becomes the initial flow traffic volume parameter for the new flow. Otherwise, if the evaluated packet is not part of a new flow, then an increasing operation 810 increases the flow traffic volume of the already present flow by the size of the packet.

An interrupt operation 812 determines whether a condition has interrupted the monitoring operation (collectively, operations 804, 806, 808, and 810). In one case, the interruption may be in the form of a memory full signal, which indicates that the last inserting operation 808 filled the flow memory. If so, the processor instructs the autodetermination circuitry to cull the flow memory (e.g., using a cull signal). In response to this instruction, the autodetermination circuitry sorts the flow entries in the flow memory by flow traffic volume in a sorting operation 818, and deletes the flow entries in the flow memory that satisfy the culling condition (e.g., not in the top 100 flow entries in the sorted flow memory) in a culling operation 820. Thereafter, the flow traffic volumes of the remaining flow entries are reset in a resetting operation 822 and processing returns to the detecting operation 804.

Alternatively, the interrupt may be a congestion signal, which identifies the congested interswitch link. Congestion can be identified using a variety of techniques, one of which is to detecting that a transmit queue associated with the interswitch link is getting “full” (e.g., is filling to exceed a threshold or has overflowed). An identifying operation 814 accesses the flow memory associated with the identified congested interswitch link and identifies one or more of the flows at the top of the flow memory. A remediating operation 816 executes remedial action, such as re-routing, rate limiting at the source device, and/or allocating additional bandwidth to the congested interswitch link. Processing then returns to the detecting operation 804 or whatever operations was interrupted by the congestion signal.

It should be understood that the identifying operation 814 may be influenced by a flow parameter filtering operation, similar to the one that can be employed in the monitoring period. That is, the flows identified by the identifying operation 814 may be dependent upon the value of its flow parameters. Example flow parameters that may be specified to filter the monitored subset, including without limitations the source identifier (SID), destination identifier (DID), logical unit number (LUN), quality of service (QoS) level, etc. If a flow does not have parameters that match the filter set, then the flow can be ignored during the identifying operation. In this manner, for example, flows with a high QoS level can be removed from identification and therefore will not be considered for remedial action—other lower QoS level flows will be candidates for identification and potentially selected for remedial action.

It should be understood that, although the flow diagram on FIG. 8 depicts this interrupt operation 812 as a strictly sequential operation after one of the operations 808 and 810, the interrupt operation 812 can execute asynchronously to the other operations 800. For example, at any point within the operations 800, the network controller device can detect link congestion and interrupt the processor, passing the identity of one or more high volume flows in an identifying operation 814 to the processor. Thereafter, the processor executes remedial action based on one or more of the identified high volume flows in a remediation operation 816. Thereafter, processing returns to the detecting operation 804.

If the interrupt operation 812 does not detect congestion and does not determine that the flow memory is full, then processing returns to the detecting operation 804. Although not shown in the operations 800, the flow autodetermination process can be terminated in some implementations.

FIG. 9 illustrates example operations 900 for determining flows contributing to congestion on a link. Instead of starting a monitoring period at system start or as some arbitrary point during operation (e.g., in response to an administrative command), a monitoring period may be initiated responsive to detection of a congestion condition on a link.

Accordingly, a congestion monitoring operation 901 monitors for congestion on an interswitch link. A congestion decision 903 determines whether a congestion condition has been satisfied. If not, processing returns to the congestion monitoring operation 901. Otherwise, a congestion signal is communicated to the processor, identifying the congested link. Responsive to receipt of the congestion signal, an initiating operation 902 starts flow autodetermination within a network switching device for the identified congested link.

A detecting operation 904 evaluates a packet the network switching device transmits across a specific interswitch link, examining the packet's SID and DID and potentially other flow parameters. A decision operation 906 checks the flow memory to determine whether the flow associated with the evaluated packet is not already inserted into the flow memory. If not, the flow is a new flow and the SID, DID, and packet size of the packet are inserted into available space in the flow memory by an inserting operation 908. The size of the packet becomes the initial flow traffic volume parameter for the new flow. Otherwise, if the evaluated packet is not part of a new flow, then an increasing operation 910 increases the flow traffic volume of the already present flow by the size of the packet.

An interrupt operation 912 determines whether a condition has interrupted the monitoring operation (collectively, operations 904, 906, 908, and 910). In one case, the interruption may be in the form of a memory full signal, which indicates that the last inserting operation 908 filled the flow memory. If so, the processor instructs the autodetermination circuitry to cull the flow memory (e.g., using a cull signal). In response to this instruction, the autodetermination circuitry sorts the flow entries in the flow memory by flow traffic volume in a sorting operation 918, and deletes the flow entries in the flow memory that satisfy the culling condition (e.g., not in the top 100 flow entries in the sorted flow memory) in a culling operation 920. Thereafter, the flow traffic volumes of the remaining flow entries are reset in a resetting operation 922 and processing returns to the detecting operation 904.

Alternatively, the interrupt may be an end monitoring period signal, which indicates that enough monitoring has been performed to make a good prediction of one or more offending flows. In various implementation, the end monitoring period signal issues after a predetermined period of time or in response to another switch condition being met (e.g., issuance of a specified number of memory full signals). Other conditions may be employed to trigger issuance of an end monitoring period signal.

An identifying operation 914 accesses the flow memory associated with the identified congested interswitch link and identifies one or more of the flows at the top of the flow memory. A remediating operation 916 executes remedial action, such as re-routing, rate limiting at the source device, and/or allocating additional bandwidth to the congested interswitch link. Processing then returns to the detecting operation 904 or whatever operations was interrupted by the congestion signal.

It should be understood that the identifying operation 914 may be influenced by a flow parameter filtering operation, similar to the one that can be employed in the monitoring period. That is, the flows identified by the identifying operation 914 may be dependent upon the value of its flow parameters. Example flow parameters that may be specified to filter the monitored subset, including without limitations the source identifier (SID), destination identifier (DID), logical unit number (LUN), quality of service (QoS) level, etc. If a flow does not have parameters that match the filter set, then the flow can be ignored during the identifying operation. In this manner, for example, flows with a high QoS level can be removed from identification and therefore will not be considered for remedial action—other lower QoS level flows will be candidates for identification and potentially selected for remedial action.

It should also be understood that, although the flow diagram on FIG. 9 depicts this interrupt operation 912 as a strictly sequential operation after one of the operations 908 and 910, the interrupt operation 912 can execute asynchronously to the other operations 900. For example, at any point within the operations 900, the network controller device interrupt the processor, passing the identity of one or more high volume flows in an identifying operation 914 to the processor. Thereafter, the processor executes remedial action based on one or more of the identified high volume flows in a remediation operation 916. Thereafter, an optional terminating operation 917 terminates flow autodetermination and processing returns to the congestion monitoring operation 901.

If the interrupt operation 912 does not detect a full memory signal or an end monitoring period signal, then processing returns to the detecting operation 904. Although not shown in the operations 900, the flow autodetermination process can be terminated in some implementations.

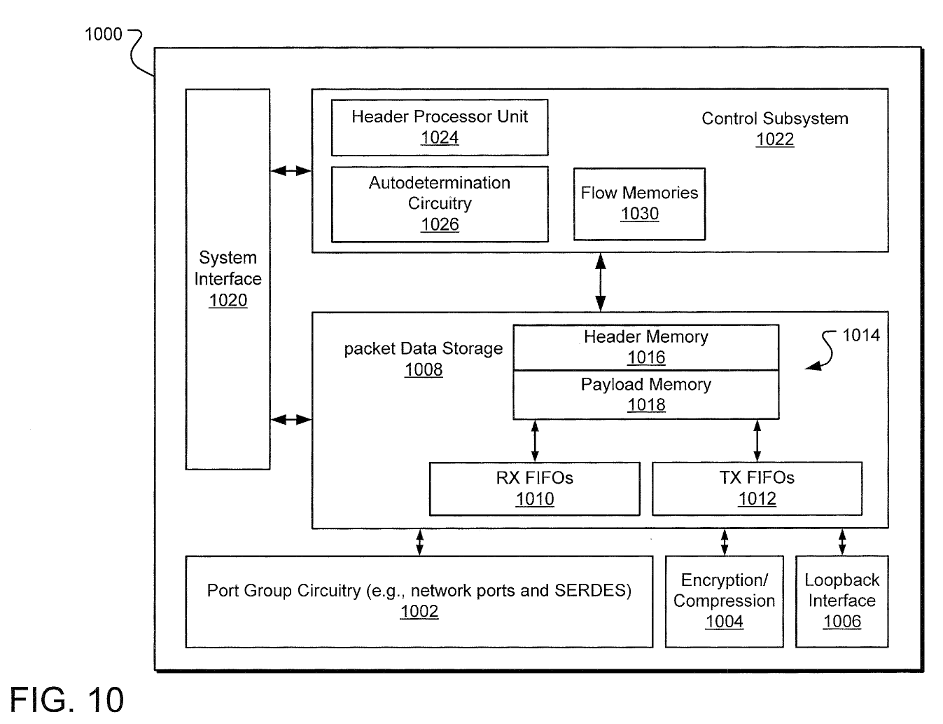

FIG. 10 illustrates an architecture of an example Fibre Channel Controller 1000 in which the autodetermination features can be implemented. Port group circuitry 1002 includes the Fibre Channel ports and Serializers/Deserializers (SERDES) for the network interface. Data packets are received and transmitted through the port group circuitry 1002 during operation. Encryption/compression circuitry 1004 contains logic to carry out encryption/compression or decompression/decryption operations on received and transmitted packets. The encryption/compression circuitry 1004 is connected to 6 internal ports and can support up to a maximum of 65 Gbps bandwidth for compression/decompression and 32 Gbps bandwidth for encryptions/decryption, although other configurations may support larger bandwidths for both. A loopback interface 1006 is used to support Switched Port Analyzer (SPAN) functionality by looping outgoing packets back to packet buffer memory.

Packet data storage 1008 includes receive (RX) FIFOs 1010 and transmit (TX) FIFOs 1012 assorted receive and transmit queues. The packet data storage 1008 also includes control circuitry (not shown) and centralized packet buffer memory 1014, which includes two separate physical memory interfaces: one to hold the packet header (i.e., header memory 1016) and the other to hold the payload (i.e., payload memory 1018). A system interface 1020 provides a processor within the switch with a programming and internal communications interface. The system interface 1020 includes without limitation a PCI Express Core, a DMA engine to deliver packets, a packet generator to support multicast/hello/network latency features, a DMA engine to upload statistics to the processor, and top-level register interface block.

A control subsystem 1022 includes without limitation a header processing unit 1024 that contains switch control path functional blocks. All arriving packet descriptors are sequenced and passed through a pipeline of the header processor unit 1024 and filtering blocks until they reach their destination transmit queue. The header processor unit 1024 carries out L2 Switching, Fibre Channel Routing, LUN Zoning, LUN redirection, Link table Statistics, VSAN routing, Hard Zoning, SPAN support, and Encryption/Decryption. The control subsystem 1022 also includes autodetermination circuitry 1026 that interfaces with the system interface 1020 and the header processing unit 1024 to monitor transmitted data packets, detect flows and load them into an appropriate flow memory 1030 for the transmission link, execute sorting and culling, and identify the flows associated with the highest flow volumes.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A network switching device comprising:
a flow memory configured to record flow entries, each flow entry including a flow identifier and a flow traffic volume; and
autodetermination circuitry coupled to the flow memory and configured to learn flow identifiers and flow traffic volumes for recording as flow entries in the flow memory and to unlearn a subset of the recorded flow entries in the flow memory, each unlearned flow entry having a flow traffic volume that satisfies a culling condition.

2. The network switching device of claim 1 wherein the autodetermination circuitry is further configured to examine a packet to identify a flow associated with the packet.

3. The network switching device of claim 1 wherein each flow identifier includes a source identifier and a destination identifier.

4. The network switching device of claim 1 wherein the autodetermination circuitry is further configured to determine a size of the packet, wherein the size of the packet contributes to flow traffic volume of the flow entry associated with the packet.

5. The network switching device of claim 1 wherein the autodetermination circuitry is further configured to examine one or more flow parameters of a packet monitored by the network switching device and to filter out the packet if the flow parameters satisfy a filter condition.

6. The network switching device of claim 1 wherein the autodetermination circuitry is configured to learn by recording the flow identifiers and flow traffic volumes of flows not recorded in the flow memory as new flow entries in the flow memory.

7. The network switching device of claim 1 wherein the autodetermination circuitry is configured to learn by adding a size of a packet to a flow traffic volume field of a flow entry associated with a flow recorded in the flow memory.

8. The network switching device of claim 1 wherein the autodetermination circuitry is configured to unlearn by culling flow entries from the flow memory.

9. The network switching device of claim 1 wherein the autodetermination circuitry is configured to cull flow entries by deleting flow entries from the flow memory.

10. The network switching device of claim 1 wherein the culling condition includes an entry count condition based on a number of flow entries.

11. The network switching device of claim 1 wherein the culling condition includes a traffic volume condition based on a flow traffic volume.

12. A method comprising:
learning flow identifiers and flow traffic volumes for recording in flow entries in a flow memory, each flow entry including a flow identifier and a flow traffic volume; and
unlearning a subset of the recorded flow entries in the flow memory, each unlearned flow entry having a flow traffic volume that satisfies a culling condition.

13. The method of claim 12 wherein the learning operation comprises:
examining a packet to identify a flow associated with the packet.

14. The method of claim 12 wherein the flow associated with the packet is identified by a source identifier and a destination identifier of the packet.

15. The method of claim 12 wherein the examining operation comprises:
determining a size of the packet, wherein the size of the packet contributes to flow traffic volume of the flow entry associated with the packet.

16. The method of claim 12 further comprising:
examining one or more flow parameters of a packet; and
filtering out the packet if the flow parameters satisfy a filter condition.

17. The method of claim 12 wherein learning operation comprises:
recording the flow identifiers and flow traffic volumes of flows not recorded in the flow memory as new flow entries in the flow memory.

18. The method of claim 12 wherein the learning operation comprises:
adding a size of a packet to a flow traffic volume field of a flow entry associated with a flow recorded in the flow memory.

19. The method of claim 12 wherein the unlearning operation comprises:
culling flow entries from the flow memory.

20. The method of claim 12 wherein the culling condition includes an entry count condition based on a number of flow entries.

21. The method of claim 12 wherein the culling condition includes a traffic volume condition based on a flow traffic volume.
